(19) United States
(12) Patent Application Publication
(10) Pub. No.: US 2012/0054873 A1
(43) Pub. Date: Mar. 1, 2012

(54) METHOD AND SYSTEM FOR PROTECTING MODEL DATA

(75) Inventors: Chen Hao, Beijing (CN); Qi Cheng Li, Beijing (CN); Jian Wang, Beijing (CN); Yi Min Wang, Beijing (CN); Shun Xiang Yang, Beijing (CN); Zi Yu Zhu, Beijing (CN)

(73) Assignee: International Business Machines Corporation, Armonk, NY (US)

(21) Appl. No.: 13/213,474

(22) Filed: Aug. 19, 2011

(30) Foreign Application Priority Data
Aug. 27, 2010 (CN) 201010270537.1

(51) Int. Cl. H04L 9/00

(52) U.S. Cl. 726/26

(57) ABSTRACT

A method and system for protecting model data. The method includes obtaining model data, identifying a type of the model data, sending at least a portion of a first type of the model data to a first rendering pipeline for rendering if the model data is identified as the first type of the model data, where the first rendering pipeline is a confidential rendering pipeline, and sending a second type of the model data to a second rendering pipeline for rendering if the model data is identified as the second type of the model data. With the method and system of the present application, model data of an application or service provider can be protected without overly increasing the load on the server.

### CROSS-REFERENCE TO RELATED APPLICATION

This application claims priority under 35 U.S.C. §119 from Chinese Patent Application No. 201010270537.1 filed Aug. 27, 2010, the entire contents of which are incorporated herein by reference.

### FIELD OF THE INVENTION

The present invention generally relates to the technical field of information processing, and particularly relates to a method and system for protecting model data.

### DESCRIPTION OF RELATED ART

In the present day, in applications or services such as network and game, the content provider or application provider provides users with a large amount of two dimensional (2D) or three dimensional (3D) model data. Many of these model data are loaded into a client. Some of the model data are developed by the content provider or application provider using a large amount of human and financial resources, making the model data of relatively high value. Some techniques that obtain these model data currently exist, but these model data can be used in a manner which is not desired by the content provider or application provider. The content provider or application provider may hope to protect the related model data by encrypting them, but in practice this is not sufficient.

In an example of the 3D model data, as shown in FIG. 1, although encrypted data files are loaded from a server or a client hard disk, all of the existing 3D applications issue a command of drawing a graphic to a standard rendering pipeline on the bottom level via general programming interfaces (OpenGL, Direct3D). At an entrance that the decrypted 3D model data enter the rendering pipeline, all of the model data can be listened by a third party program. The listening program can obtain complete 3D geometric shapes and related texture files of the model only by saving the data entering the standard rendering pipeline.

FIG. 2 shows a standard rendering pipeline. A rendering pipeline component converts input 3D scene data into appropriate 2D model data according to camera data, and then a rendering object component clips the generated 2D model data according to the viewport data (window or clipping window) of the corresponding avatar and projects the 2D model data onto the predetermined viewport. The rendering result obtained by rendering is stored in a frame buffer memory as a frame buffer. For details of the prior art of the rendering pipeline, reference can be made to the related description in Wikipedia (http://en.wikipedia.org/wiki/Graphics_pipeline) and related classic textbooks such as James D. Foley, Andries Van Dam, Steven K. Feiner and John F. Hughes (1995). “Computer Graphics: Principles and Practice”, Addison-Wesley.

Therefore, a method or system for protecting model data is needed to provide a certain protection to the model data of the content/application provider.

### SUMMARY OF THE INVENTION

The present invention provides a method and system for protecting model data.

In one aspect, the present invention provides a method for protecting model data, wherein the method includes obtaining model data, identifying a type of the model data, sending at least a portion of an identified first type of the model data to a first rendering pipeline for rendering if the model data is identified as the first type of the model data, where the first rendering pipeline is a confidential rendering pipeline, and sending an identified second type of the model data to a second rendering pipeline for rendering if the model data is identified as the second type of the model data.

In another aspect, the present invention provides a system for protecting model data, where the system includes an obtaining means for obtaining model data, an identifying means for identifying a type of the model data, a first sending means for sending at least a portion of an identified first type of the model data to a first rendering pipeline for rendering if the model data is identified as a first type of the model data, where the first rendering pipeline is a confidential rendering pipeline and a second sending means for sending an identified second type of the model data to a second rendering pipeline for rendering if the model data is identified as a second type of the model data.

With the present method and system, model data necessary to be confidential will no longer be completely obtained by a third party listening program, and the third party listening program can only obtain a portion of a first type of the model data which is visible in the current view frustum with several parts missing, thereby protecting the model data of an application/service provider. Furthermore, employing the method of the present invention will not impose over load on the server.

### BRIEF DESCRIPTION OF THE DRAWINGS

In order to describe the features and advantages of embodiments of the present invention in detail, references will be made to the following figures. If possible, same or similar reference numerals are used in the figures and the description to indicate same or similar portions, wherein:

FIG. 1 shows a method of listening model data in the prior art;

FIG. 2 shows a schematic diagram of a standard rendering pipeline;

FIG. 3 shows a first embodiment of a method for protecting model data according to the present invention;

FIG. 4 shows an example of three dimensional model;

FIG. 5 shows a second embodiment of a method for protecting model data according to the present invention;

FIGS. 6 and 7 show an embodiment of implementing a confidential rendering pipeline of the present invention; and

FIG. 8 shows a schematic diagram of a system for protecting model data of the present invention.

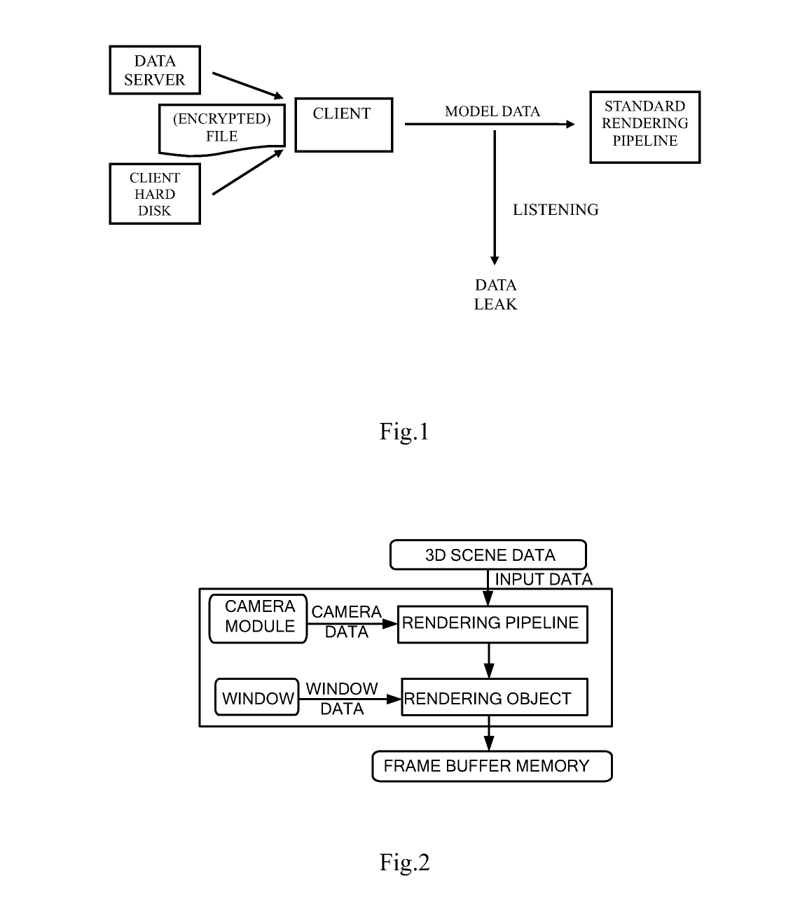

### DETAILED DESCRIPTION OF THE PREFERRED EMBODIMENTS

It should be understood that the present invention is not limited to the disclosed exemplary embodiments. It should be further understood that not every feature of the method and the apparatus is necessary for implementing the present invention as claimed by any one of the claims. The steps of the method can be carried out in any order or simultaneously, unless it is clear from the context that one step depends on another step which is carried out previously. In addition, a significant time interval may exist between the steps.

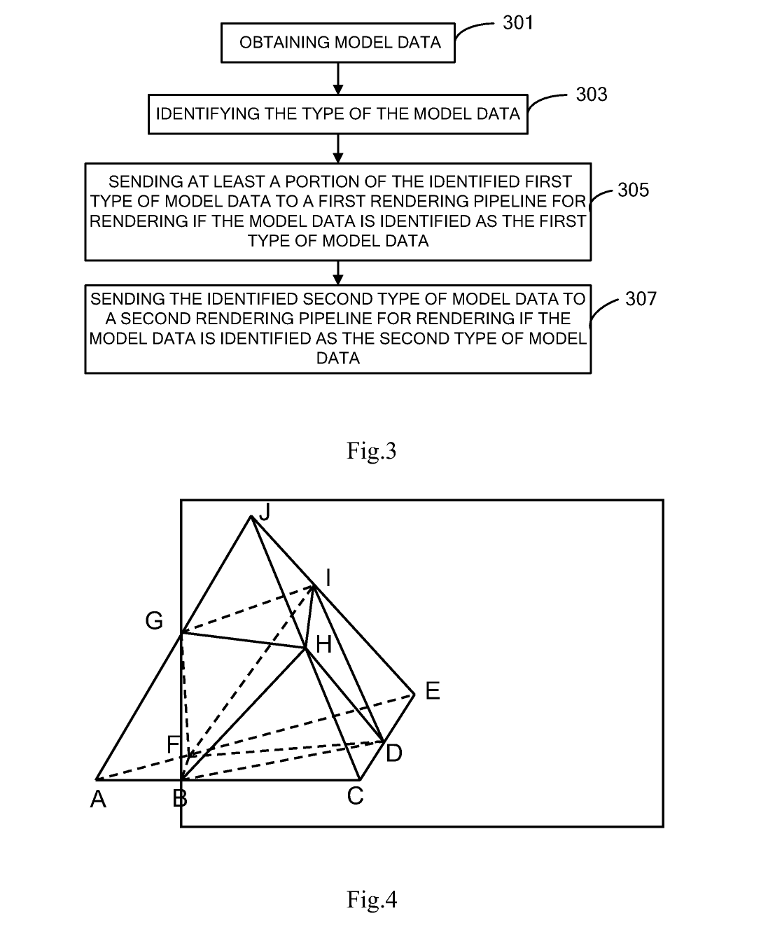

FIG. 3 shows a first embodiment of protecting model data according to the present invention. In the first embodiment, in step 301, model data is obtained. Encrypted model data may be obtained by a server from its database for storing scene data, or obtained by an application program of a client from a hard disk of the client (where the model data is stored in the hard disk by the user when installing the application program), or the related model data is sent to the client by the server for modeling or rendering of virtual scenes.

In step 303, a type of the model data is identified. In an example of the 3D model data, a large number of 3D models will be used in a 3D application. Some of the models are of relatively low commercial value, for example, ordinary houses and vegetation; and some of the models are of relatively high commercial value, and these models are considered as confidential information. Model data may have various data structures according to actual need. An exemplary model which is a triangular mesh model is as shown in FIG. 4. The model data thereof may be like the following form:

IsConfidential=1 (flag indicating confidential or not);

Vertex number=12 (number of vertices);

Face number=16 (number of faces);

List of vertices:
A={X_{A},Y_{A},Z_{A}}
B={X_{B},Y_{B},Z_{B}}
. . .
J={X_{J},Y_{J},Z_{J}}

List of faces:
FACE₁={A,B,F};
FACE₂={B,C,D};
. . .

The flag IsConfidential is used for indicating whether the model is confidential or not. For example, if IsConfidential=0, indicated is this model data is not confidential; if IsConfidential=1, indicated is this model data is confidential. By identifying the flag bit IsConfidential, it is determined which model data need special processing, and which model data can be processed according to standard procedures. Of course, the model data can be further classified according to the need, for example, prescribing different confidential levels for the confidential model data. The various model data related to one scene and the relationships among them can be managed using one scene file. A scene file may have different implementations according to different applications, but the general concepts are similar. Specifically, one scene file defines one scene by a certain format (XML, for example), and it describes all the model elements within the scene and their attributes, including terrain, water surface and objects, etc. The content of a typical scene file may be as follows:

<Scene>
<Terrain>....</Terrain>
<Water>...</Water>
<ObjectGroup>
<Object name=“Object 1” position=“0 0 0”
file=“someObject1.mesh”></Object>
<Object name=“Object 2” position=“1 2 3”
file=“someObject2.mesh”></Object>
</ObjectGroup>
</Scene>

The scene file may be collected in the server for management, or sent to the client along with the model data file by the server to ensure consistency of model data type definition. Alternatively, confidential flag bit IsConfidential may be set in the scene file, and thus the properties of the model data are uniformly managed. The above model data and scene file are only illustrative, and they should not be understood as limiting the present invention. Those skilled in the art can construct various types of model data and scene files according to actual applications based on the present invention.

In step 305, if the model data is identified as a first type of the model data, at least a portion of the identified first type of the model data is sent to a first rendering pipeline for rendering. Illustratively, the confidential model data may be considered as the first type of the model data, and at least a portion thereof is sent to the first rendering pipeline which has confidentiality functions for subsequent rendering. The first rendering pipeline may be arranged at the server end. Since the first rendering pipeline is at the server end, listening programs cannot steal the first type of the model data at the server end, so that the confidential model data is protected. The first rendering pipeline may be a standard rendering pipeline disposed at the server (for example, rendering via hardware video card). Further, since the confidential first type of the model data do not account for a large percentage of the entire model data, the server and network bandwidth will not be over load in most applications or services.

Another preferred mode may be that the first rendering pipeline is implemented by the application/service provider at the client end in form of software according to the prior art of the standard rendering pipeline. Since the listening software cannot listen to private software of the application/service provider, the model data is also protected. The fundamental reason for this is that if rendering is performed using private software, a third party program would not know when the model data is transferred by the software into a rendering function for rendering, and any intermediate result and invoked function cannot be known by the third party program either, and finally only a two dimensional rendering result is output to the screen, thus this process cannot be listened by the third party program.

More detailed description will be made for this preferred embodiment later. Since the model data may be stored at the server end or the client end according to different embodiments, “sending” as mentioned here is related to the specific disposition of the method of the present invention, and may be sending from the server to the first rendering pipeline, or sending from the client to the first rendering pipeline.

Proceeding to step 307, if the model data is identified as a second type of the model data, the identified second type of the model data is sent to a second rendering pipeline for rendering. Illustratively, ordinary model data may be considered as the second type of the model data, and are sent to the second rendering pipeline which is different from the first rendering pipeline. The difference between the first rendering pipeline and the second rendering pipeline may be different locations of disposition, for example, the second rendering pipeline may be a standard rendering pipeline disposed at the client end while the first rendering pipeline may be a standard rendering pipeline disposed in the server. The difference between the first rendering pipeline and the second rendering pipeline may also be different modes of implementation, for example, the second rendering pipeline is implemented in hardware or software and in form of commonly known open programming interfaces (OpenGL or Direct3D, for example) while the first rendering pipeline is implemented in form of private software so that the listening program cannot obtain the confidential model data.

It is noticeable that, no matter the first rendering pipeline or the second rendering pipeline, preferably, they both use parameters based on (which may be from the client) the same camera position, camera angle, lighting, texture, etc. during the rendering, so as to ensure that the different data model subject to renderings of different rendering pipelines can be finally combined together. Of course, if different parameters are used, their corresponding relationships and conversion relationships can be recorded to ensure that they can be recombined together according to the coordinate conversion relationships upon being recombined later, since rendering is mathematically a space mapping relationship from a three dimensional space to a two dimensional space.

Like the existing common practice, after the first and second types of model data have undergone renderings of the first and the second rendering pipelines, they will be projected onto corresponding areas on a same two dimensional screen. Thereby, multiple models in the scene are displayed together. After the projection, there may be overlaps between the models. In this case, additional depth information (z value) can be used to determine which model should be placed on an upper layer. Regarding recombination techniques of the rendering results, reference can be made to James D. Foley, Andries Van Dam, Steven K. Feiner and John F. Hughes (1995). “Computer Graphics: Principles and Practice”. Addison-Wesley, etc. for details, and the details will be omitted.

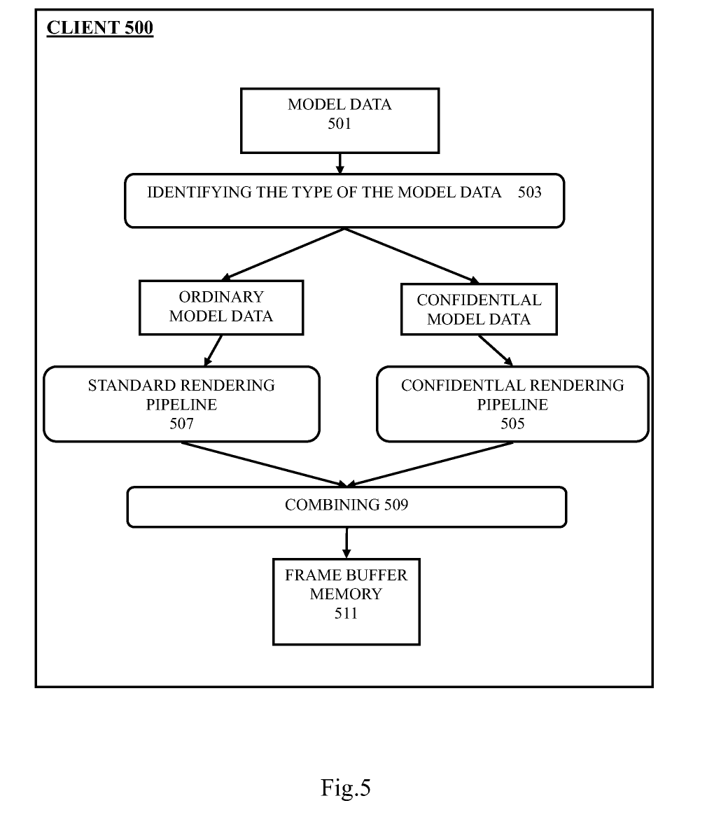

FIG. 5 shows a second embodiment of the present invention. This method is disposed at the client 500 end. Initially, a user of the application or service has obtained encrypted model data and an application/service client application program from the application/service provider. In step 501, the client application program will obtain the model data and perform decryption. Before sending the model data to the rendering pipeline, a type of the model data will be identified in step 503. Identification of the type of the model data can be performed by identifying the flag in the model data file as in the first embodiment. After distinguishing the type of the model data, in step 505, the model data necessary to be confidential will be sent to the confidential rendering pipeline for rendering, the confidential rendering pipeline is implemented by the application/service provider at the client end in form of software according to the prior art of the standard rendering pipeline.

Since the listening software cannot listen to private software of the application/service provider, the model data is protected. Preferably, it can be also considered that only a portion of data of the confidential model data is sent to the confidential rendering pipeline for rendering, and the rest of the confidential model data is sent to the standard pipeline for rendering, and their corresponding relationships are recorded and they are recombined in the end. In this way, the standard rendering pipeline can be sufficiently utilized and the load on the confidential rendering pipeline and the CPU can be reduced. In the present application, this preferred embodiment will be described in detail in a third embodiment of the present invention. On the other hand, ordinary model data will be rendered by the standard rendering pipeline at the client end in step 507. In step 509, the rendered model data from the confidential rendering pipeline and the standard rendering pipeline are combined according to an existing method, and in step 511, the final combined result is sent to a frame buffer memory so as to present related scenes for the user.

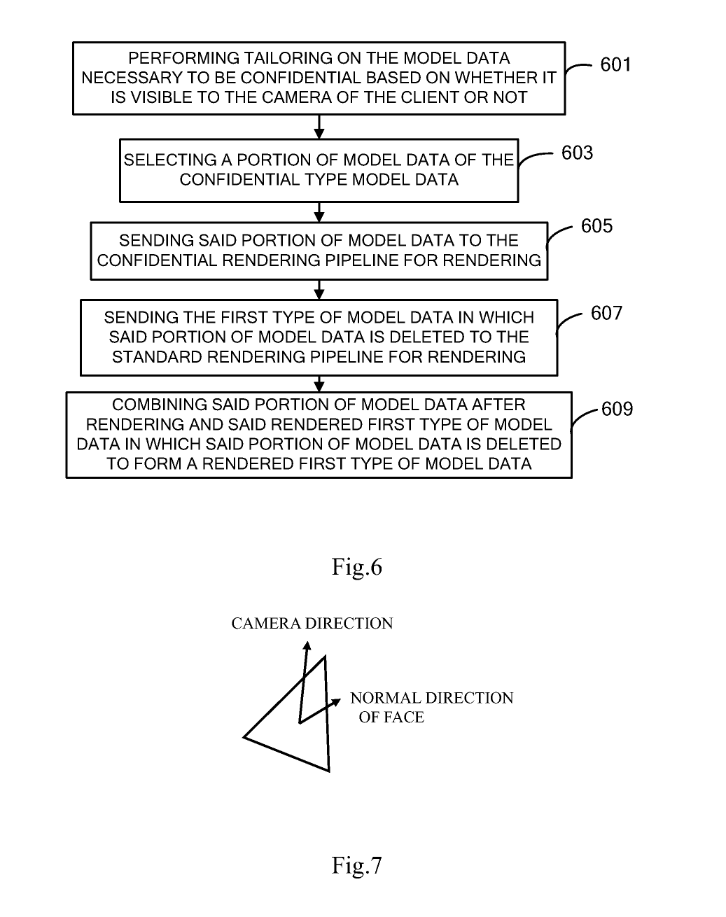

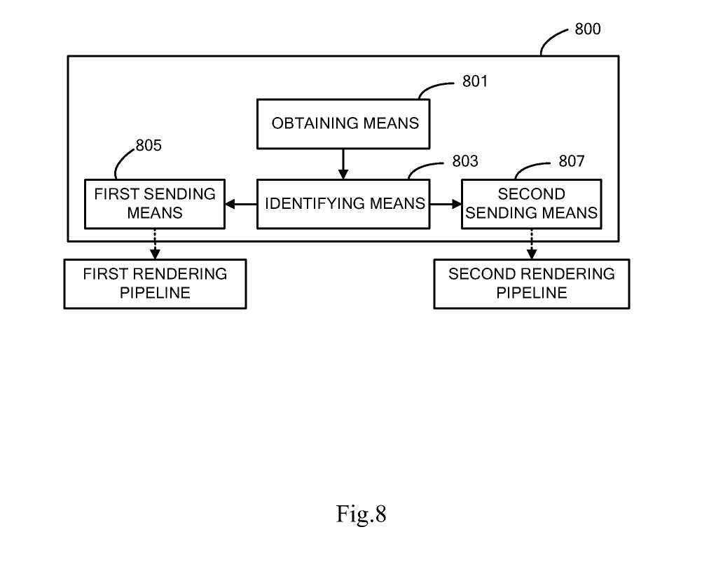

FIGS. 6 and 7 show an embodiment of implementing a confidential rendering pipeline of the present invention. As shown in step 601 of FIG. 6, before being sent to the confidential rendering pipeline, the confidential type model data is clipped depending on whether the confidential type model data is visible to the camera at the client end or not. A standard rendering pipeline will perform clipping in the process of rendering. However, in order to protect the model data, the present embodiment alternatively arranges the clipping of the model data before entering the rendering pipeline. A significant advantage of this is that even if the model data necessary to be confidential is listened in a subsequent rendering process, whoever performs listening only obtains the clipped model data instead of the complete model data. Therefore, the confidential type model data is protected to some extent.

As shown in FIG. 7, in an example of clipping of 3D model data, triangular meshes are the most commonly used in 3D model data. A triangular mesh includes of n triangle faces. For each triangle face, it can be determined as visible or not according to a normal direction of the face and a current camera direction. If an angle between the normal direction of the face and the current camera direction is larger than 90 degrees, this face is visible; if the angle equals to 90 degrees, this face is in a critical condition and what is seen is a line; if the angle is smaller than 90 degrees, this face is not visible. Therefore, elimination of hidden faces can be done by deleting the faces in the triangular mesh that have an angle of smaller than or equal to 90 degrees between their normal direction and the current camera direction. Regarding the specific technique of performing clipping on model data, reference can also be made to James D. Foley, Andries Van Dam, Steven K. Feiner and John F. Hughes (1995). “Computer Graphics: Principles and Practice”. Addison-Wesley for details.

Preferably, if the rectangular area in FIG. 4 is the illustration of the application program window, the faces {A,B,F}, {A,B,G} and {A,F,G} outside the view frustum can be first cut off according to view frustum clipping. A view frustum is a frustum defined according to camera position, camera angle, near clipping face and far clipping face. For each face of a triangular mesh, the three vertices thereof are examined. If all these three vertices are outside the frustum, this face is outside the view frustum and can be cut off. Then, the elimination based on the visibility of client camera can cut off the invisible faces such as {I,E,F} and {B,C,D}.

As an alternative embodiment, considering that the clipped confidential type model data is no longer a complete model, the confidential rendering pipeline in this case can be combined with the standard rendering pipeline, i.e., the clipped confidential type model data is sent to the standard rendering pipeline for rendering. Therefore, even if listening is performed, only the clipped confidential type model data is obtained, and the confidential type model data can be protected to some extent as well. Therefore, the following steps 603, 605, 607, 609, etc. are preferred implementation steps of the present embodiment.

In step 603, before being sent to the confidential rendering pipeline, a portion of the model data of the confidential type model data is selected, and the portion of the model data is deleted from the confidential type model data. The confidential type model data may be clipped model data. Preferably, a portion (1%, for example) of model data can be selected randomly from the confidential type model data. Preferably, a relative key portion (for example, the data of the portion of eyes, corner of mouth, etc. of human model data) of the model data may be selected. For example, the polygon area surrounded by C,D,I,H in FIG. 4 may be deleted. After the portion of the model data is selected, the portion of the model data of the confidential type model data is deleted, and, the obtained confidential type model data lack the selected portion of the model data.

In step 605, preferably, the portion of the model data is sent to the confidential rendering pipeline for rendering. As pointed out above, the confidential rendering pipeline is implemented by the application/service provider in form of software program. The portion of the model data is rendered in the confidential rendering pipeline formed by software program. Since data amount of the portion of the model data is relatively small, the rendering load of this portion is also relatively small and the rendering can be totally performed using the computing capability of the CPU, but the listening software cannot listen to this process. After being rendered by the confidential rendering pipeline, the portion of the model data is pixelized to form a corresponding two dimensional image.

In step 607, preferably, the first type of the model data in which the portion of the model data is deleted is sent to the standard rendering pipeline for rendering. Since the portion of the model data which is rendered in the standard rendering pipeline is relatively fragmentary model data, even if being listened, the other party only obtains incomplete model data, and thus the confidential type model data is correspondingly protected.

Proceeding to step 609, after being rendered, the portion of the model data and the first type of the model data in which the portion of the model data is deleted are combined to form a rendered first type of the model data. According to the original coordinates, relationship between the portion of the model data and the first type of the model data in which the portion of the model data is deleted, the rendered first type of the model data is obtained by recombining. The portion of the model data and the rest of the first type of the model data have a uniform coordinate system so that according to the originally recorded coordinate relationship and the same parameters such as camera position, camera angle, lighting, texture that are used during the rendering, the portion of the model data after rendering and the rendered first type of the model data in which the portion of the model data is deleted can be combined together, thereby obtaining the rendered image of the complete confidential type model data.

In the end, as described before, the rendered confidential type model data and ordinary type data are combined. Although the portion of the model data is rendered by the confidential rendering pipeline, the coordinate data of the portion of the model data is not changed during the selection process, and the confidential rendering pipeline and the standard rendering pipeline use the same parameters such as camera position, camera angle, lighting, texture. The rendering result of the portion of the model data and its position projected onto the plane will not be changed due to using a different rendering pipeline. Therefore, the portion of the model data after rendering and the rendered first type of the model data in which the portion of the model data is deleted can be combined together, thereby obtaining the rendered image of the complete confidential type model data.

In addition, as an alternative embodiment, the selected portion of the model data can be sent to a standard rendering pipeline disposed at the server side (or software program which serve as a rendering pipeline) for rendering, the confidential type of the model data in which the portion of the model data is deleted is sent to the standard pipeline at the client end for rendering, and finally the two portions of rendered model data are combined. In this way, the rendering load on the server can be further greatly reduced, and the confidentiality can be enhanced.

The present invention also provides a system 800 for protecting model data. The system 800 includes an obtaining means 801 for obtaining model data, an identifying means 803 for identifying a type of the model data, a first sending means 805 for sending at least a portion of an identified first type of the model data to a first rendering pipeline for rendering if the model data is identified as the first type of the model data, wherein the first rendering pipeline is a confidential rendering pipeline, a second sending means 807 for sending an identified second type of the model data to a second rendering pipeline for rendering if the model data is identified as the second type of the model data. The related implementation of the above means of the system 800 is above described in detail, and the description is omitted here.

Preferably, the system 800 further comprises: a means for performing clipping on the first type of the model data based on whether it is visible to the camera at the client end or not before the first type of the model data is sent to the first rendering pipeline.

Preferably, the system 800 further comprises: a means for selecting a portion of the model data of the first type of the model data before the first type of the model data is sent to the first rendering pipeline; and a means for deleting said portion of the model data from said first type of the model data.

Preferably, said first sending means 805 comprises: a means for sending said portion of the model data to said first rendering pipeline.

Preferably, said system 800 further comprises: a means for sending the first type of the model data in which said portion of the model data is deleted to the second rendering pipeline for rending.

Preferably, said system 800 further comprises: a means for combining said portion of the model data after rendering and said rendered first type of the model data in which said portion of the model data is deleted to form a rendered first type of the model data; and a means for combining the rendered first and second types of the model data.

Preferably, said means for combining said portion of the model data after rendering and said rendered first type of the model data in which said portion of the model data is deleted to form a rendered first type of the model data further comprises: a means for obtaining the rendered first type of the model data by combining according to a corresponding original position relationship between said portion of the model data and said first type of the model data in which said portion of the model data is deleted.

Preferably, the first rendering pipeline is disposed at the server end, and the second rendering pipeline is disposed at the client end.

Preferably, the first rendering pipeline is software program, and the second rendering pipeline is a standard hardware rendering pipeline.

Preferably, the type of said model data is labeled by a flag in a model data file.

Furthermore, the method for protecting model data according to the present invention may be also implemented by a computer program product, the computer program product including a software code portion to be executed to implement a simulation method of the present invention when the computer program product is run on a computer.

The present invention can be implemented by recording a computer program in a computer readable recording medium, which includes a software code portion to be executed to implement a simulation method of the present invention when the computer program is run on a computer. In other words, a process of the simulation method according to the present invention may be distributed in form of instructions in a computer readable medium or various other forms, regardless of the specific type of the signal carrying medium actually used for performing distribution. Examples of computer readable medium includes a medium such as EPROM, ROM, magnetic tape, paper, floppy disk, hard disk drive, RAM and CD-ROM and a transmission type medium such as digital and analog communication links.

Although the present invention is described with reference to the preferred embodiments of the present invention, it is understood by those skilled in the art that various modifications to the forms and details thereof can be made without departing from the spirit and scope of the present invention as defined by the appended claims.

We claim:

1. A method for protecting model data, comprising:
obtaining model data;
identifying a type of the model data;
sending at least a portion of a first type of the model data to a first rendering pipeline for rendering if the model data is identified as the first type of the model data, wherein the first rendering pipeline is a confidential rendering pipeline; and
sending a second type of the model data to a second rendering pipeline for rendering if the model data is identified as the second type of the model data.

2. The method according to claim 1, further comprising:
performing clipping on the first type of the model data based on whether the first type of the model data is visible to a camera at a client end or not before at least a portion of the first type of the model data is sent to the first rendering pipeline.

3. The method according to claim 1, further comprising:
selecting a portion of the model data of the first type of the model data before at least a portion of the first type of the model data is sent to the first rendering pipeline; and
deleting said portion of the model data from said first type of the model data,
wherein said sending at least a portion of the first type of the model data to the first rendering pipeline includes sending said portion of the model data to said first rendering pipeline.

4. The method according to claim 3, further comprising:
sending the first type of the model data in which said portion of the model data is deleted to the second rendering pipeline for rending.

5. The method according to claim 4, further comprising:
combining said portion of the model data after rendering and said rendered first type of the model data in which said portion of the model data is deleted to form a rendered first type of the model data; and
combining the rendered first and second types of the model data.

6. The method according to claim 5, wherein said combining said portion of the model data after rendering and said rendered first type of the model data in which said portion of the model data is deleted to form a rendered first type of the model data further comprises:
obtaining the rendered first type of the model data by combining according to a corresponding original position relationship between said portion of the model data and said first type of the model data in which said portion of the model data is deleted.

7. The method according to claim 1, wherein the first rendering pipeline is disposed at a server end and the second rendering pipeline is disposed at a client end.

8. The method according to claim 1, wherein the first rendering pipeline is software program and the second rendering pipeline is a standard hardware rendering pipeline.

9. The method according to claim 1, wherein the type of said model data is labeled by a flag in a model data file.

10. The method according to claim 1, wherein the first rendering pipeline and the second rendering pipeline use a same camera position and camera angle during the rendering.

11. A system for protecting model data, comprising:
an obtaining means for obtaining model data;
an identifying means for identifying a type of the model data;
a first sending means for sending at least a portion of an identified first type of the model data to a first rendering pipeline for rendering if the model data is identified as a first type of the model data, wherein the first rendering pipeline is a confidential rendering pipeline; and
a second sending means for sending an identified second type of the model data to a second rendering pipeline for rendering if the model data is identified as a second type of the model data.

12. The system according to claim 11, further comprising:
a means for performing clipping on the first type of the model data based on whether the first type of the model data is visible to a camera at a client end or not before at least a portion of the first type of the model data is sent to the first rendering pipeline.

13. The system according to claim 11, further comprising:
a means for selecting a portion of the model data of the first type of the model data before at least a portion of the first type of the model data is sent to the first rendering pipeline;
a means for deleting said portion of the model data from said first type of the model data,
wherein said first sending means includes a means for sending said portion of the model data to said first rendering pipeline.

14. The system according to claim 13, further comprising:
a means for sending the first type of the model data in which said portion of the model data is deleted to the second rendering pipeline for rending.

15. The system according to claim 14, further comprising:
a means for combining said portion of the model data after rendering and said rendered first type of the model data in which said portion of the model data is deleted to form a rendered first type of the model data; and
a means for combining the rendered first and second types of the model data.

16. The system according to claim 15, wherein said means for combining said portion of the model data after rendering and said rendered first type of the model data in which said portion of the model data is deleted to form a rendered first type of the model data further comprises:
a means for obtaining the rendered first type of the model data by combining according to a corresponding original position relationship between said portion of the model data and said first type of the model data in which said portion of the model data is deleted.

17. The system according to claim 11, wherein the first rendering pipeline is disposed at a server end and the second rendering pipeline is disposed at a client end.

18. The system according to claim 11, wherein the first rendering pipeline is software program and the second rendering pipeline is a standard hardware rendering pipeline.

19. The system according to claim 11, wherein the type of said model data is labeled by a flag in a model data file.

20. A computer readable storage medium tangibly embodying a computer readable program code having computer readable instructions which, when implemented, cause a computer to carry out the steps of a method comprising claim 1.
